(19) United States
(12) Patent Application Publication
(10) Pub. No.: US 2025/0232058 A1
(43) Pub. Date: Jul. 17, 2025

(54) End to End Protocol of Frequency Estimation with Multi-Party Computation

(71) Applicant: Google LLC, Mount View, CA (US)

(72) Inventors: Badih Ghazi, Cupertino, CA (US); Benjamin Kreuter, Jersey City, NJ (US); Phi Hung Le, New York, NY (US); Baiyu Li, San Mateo, CA (US); Pasin Manurangsi, Bangkok (TH); Raimundo Mirisola, Los Angeles, CA (US); Jiayu Peng, Sunnyvale, CA (US); Shanmugasundaram Ravikumar, Piedmont, CA (US); Mariana Raykova, New York, NY (US); Chenwei Wang, Mountain View, CA (US); Craig Wright, Louisville, CO (US)

(21) Appl. No.: 18/702,685

(22) PCT Filed: Dec. 13, 2023
(86) PCT No.: PCT/US2023/083736

§ 371 Date: Apr. 18, 2024

Related U.S. Application Data
(60) Provisional application No. 63/467,665, filed on May 19, 2023.

(51) Int. Cl. G06F 21/62

(52) U.S. Cl. CPC G06F 21/6245

(57) ABSTRACT

Aspects of the disclosure are directed to estimating a frequency histogram for users across multiple platforms while maintaining accuracy, security, privacy, and/or computational efficiency thresholds. The frequency histogram can be estimated unbiasedly with a configurable variance. The computations for generating the frequency histogram can be differentially private, satisfy provable security, and be efficient.

### CROSS-REFERENCE TO RELATED APPLICATIONS

The present application claims the benefit of the filing date of U.S. Provisional Patent Application No. 63/467,665, filed May 19, 2023, the disclosure of which is hereby incorporated herein by reference.

### BACKGROUND

Multiple platforms can track frequencies for one or more types of activities of a set of users. For example, multiple platforms can track a number of ad exposures to a set of users. Estimating a histogram of the total frequency of each user of the set of users across the multiple platforms, while maintaining accuracy, security, privacy, and/or computational efficiency standards, can be difficult when each platform of the multiple platforms only knows the frequency of each user on their side.

### BRIEF SUMMARY

Aspects of the disclosure are directed to estimating a frequency histogram for users across multiple platforms while maintaining accuracy, security, privacy, and/or computational efficiency thresholds. The frequency histogram can be estimated in an unbiased manner with a configurable variance. The computations for generating the frequency histogram can be differentially private, satisfy provable security, and be computationally efficient.

An aspect of the disclosure is directed to a method for estimating a frequency histogram, including: receiving, by one or more processors, a plurality of secret-shared sketches from a plurality of event data providers; obliviously merging, by the one or more processors, the secret-shared sketches to generate registers; aggregating, by the one or more processors, the registers to generate a frequency histogram; and adding, by the one or more processors, differentially private noise to the frequency histogram. Another aspect of the disclosure is directed to a system including: one or more processors; and one or more storage devices coupled to the one or more processors and storing instructions that, when executed by the one or more processors, cause the one or more processors to perform operations for the method for estimating a frequency histogram. Yet another aspect of the disclosure is directed to a non-transitory computer readable medium for storing instructions that, when executed by the one or more processors, cause the one or more processors to perform operations for the method for estimating a frequency histogram.

In an example, estimating the frequency histogram further includes debiasing, by the one or more processors, frequency histogram based on a reach estimate. In another example, debiasing the frequency histogram further includes debiasing frequency folding.

In yet another example, in merging the secret-shared sketches, fingerprints are binary shares and frequencies are arithmetic shares. In yet another example, in merging the secret-shared sketches, if fingerprints of two secret-shared sketches are different, then the greater fingerprint is kept together with its frequency, while if the fingerprints are the same, then the frequencies are added together. In yet another example, aggregating the registers further includes: converting arithmetic shares to binary shares; performing an equality/inequality check on the binary shares; adding the binary shares together; and converting the binary shares to arithmetic shares.

In yet another example, estimating the frequency histogram further includes: non-uniformly mapping, by the one or more processors, a user identifier to a fingerprint; generating, by the one or more processors, a sketch based on the mapping; and secret-sharing, by the one or more processors, the sketch to generate a secret-shared sketch of the plurality of secret-shared sketches. In yet another example, in non-uniformly mapping the user identifier to the fingerprint, the largest fingerprint tracked is unlikely to have collisions with other user identifiers. In yet another example, generating the sketch further includes compressing events from the user identifier and estimating a frequency distribution by tracking the frequency of the largest fingerprint per register. In yet another example, secret-sharing the sketch further comprises splitting fingerprints into binary shares and frequencies into arithmetic shares.

### BRIEF DESCRIPTION OF THE DRAWINGS

FIG. 1 depicts a block diagram of an example multi-party computation system for estimating a frequency histogram based on a plurality of event data providers according to aspects of the disclosure.

FIG. 2 depicts a block diagram of an example environment for implementing a multi-party computing system according to aspects of the disclosure.

FIG. 3 depicts a flow diagram of an example process for generating sketches that are used to estimate a frequency histogram according to aspects of the disclosure.

FIG. 4 depicts a flow diagram of an example process for generating a frequency histogram according to aspects of the disclosure.

FIG. 5 depicts a flow diagram of an example process for computing a frequency histogram according to aspects of the disclosure.

### DETAILED DESCRIPTION

The technology generally relates to estimating a frequency histogram for users across multiple platforms while maintaining accuracy, security, privacy, and/or computational efficiency standards. For example, about 90% of cost in computation efficiency can be reduced compared to alternative approaches while maintaining accuracy, privacy, and security thresholds. Further, information like reach or frequency does not need to be revealed during multi-party computation.

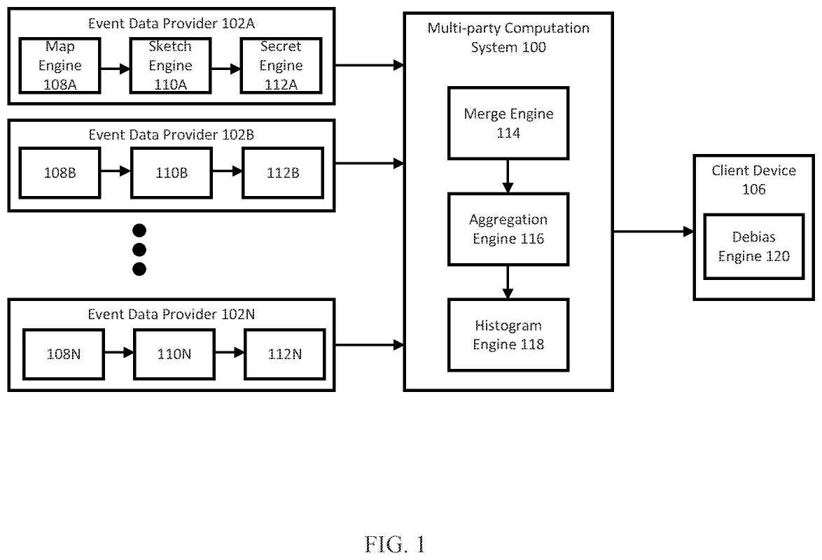

FIG. 1 depicts a block diagram of an example multi-party computation system 100 for estimating a frequency histogram based on a plurality of event data providers 102A-N. The multi-party computation system 100 can correspond to a secure computation environment where different parties, which may be referred to as workers, can complete a computation together. The event data providers 102A-N can correspond to different entities, such as different ads publishers, where their data, e.g., user identifiers like virtual identifiers, are joined in the multi-party computation system 100 for generating the frequency histogram. The multi-party computation system 100 can receive data from the event data providers 102A-N as part of a call to an application programming interface (API), through a storage medium like remote storage connected to one or more computing devices over a network, or through a user interface on a computing device coupled to the multi-party computation system 100.

From the data provided by the event data providers 102A-N, the multi-party computation system 100 can be configured to output data associated with estimating a frequency histogram. As an example, the multi-party computation system 100 can send the output data for display on a client or user device, such as client device 106, such as for an ad agency that would utilize the frequency histogram. As another example, the multi-party computation system 100 can provide the output data as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The multi-party computation system 100 can further forward the output data to one or more other devices configured for translating the output data into an executable program written in a computer programming language. The multi-party computation system 100 can also send the output data to a storage device for storage and later retrieval.

Each event data provider 102A-N i can determine the frequency freq(x,i) of their own user identifiers x on respective event data providers 102A-N, for all event data providers 1≤i≤p and for all identifiers 1≤x≤U. Here, p denotes the number of event data providers 102A-N, which can be any number, and U denotes the universe size, which can be any number of identifiers. Universe size can refer to the population size of all users. The multi-party computation system 100 or the client computing device 106 can determine a reach estimate \hat{n}. For example, reach can be expressed as n=Σₓ₌₁^{U}I(Σᵢ₌₁^{p}freq(x,i)>0), where I is an indicator function.

The event data providers 102A-N can be configured to compute predetermined hash functions that randomly map a string or integer into a float uniformly distributed in (0,1). The hash functions can include a hash h_{fgp} to determine fingerprints and a hash hₛ to construct a sketch. The event data providers 102A-N can also be configured to perform computations using predetermined fingerprint bit length B_{fgp}, fingerprint skewness rate a, and frequency bit length B_{freq}. As an example, B_{fgp}=8, a=8.0, and B_{freq}=16. The multi-party computation system 100 can include a plurality of workers for performing computations to determine the frequency histogram. The client computing device 106 can specify estimation configurations for the frequency histogram, such as sketch size m, noise variance σ², and maximum frequency K.

An estimate of the frequency histogram can be expressed as (n₁, . . . , n_{K-1}, n_{K+}), where for 1≤k≤K−1, nₖ can be the k reach nₖ=Σₓ₌₁^{U}I(Σᵢ₌₁^{p}freq(x,i)=k), and n_{K+} is the K+ reach n_{K+}=Σₓ₌₁^{U}I(Σᵢ₌₁^{p}freq(x,i)≥K).

The event data providers 102A-N can map each of their user identifiers to a fingerprint, construct sketches based on the mapping, and secret-share the sketches. The multi-party computation system 100 can merge the sketches to generate noise registers and aggregate the noise registers to compute a frequency histogram. The client computing device 106 can debias the frequency histogram based on a reach estimate.

As an example, a plurality of ad publishers can generate encrypted sketches representing ad exposure tracking for a number of users. The plurality of ad publishers can each send the encrypted sketches to a multiparty computation environment for different ad analysis companies, e.g., ad measurement companies, ad associations, etc. Through the multiparty computation environment, one or more of the different ad analysis companies merges and aggregates the encrypted sketches and generates a frequency histogram based on the aggregated encrypted sketches. The ad analysis companies can also add noise to the frequency histogram. The ad analysis companies can send the frequency histogram to an ad agency. The ad agency can debias the frequency histogram if higher accuracy is required to utilize the frequency histogram.

The event data providers 102A-N can each include a map engine 108A-N, a sketch engine 110A-N, and a secret share engine 112A-N. The map engines 108A-N, sketch engines 110A-N, and secret share engines 112A-N can be implemented as one or more computer programs, specially configured electronic circuitry, or any combination thereof. The map engines 108A-N can be configured to map each user identifier to a fingerprint. The map engines 108A-N can be configured to non-uniformly map user identifiers to fingerprints so that the largest fingerprints being tracked are unlikely to have collisions. The sketch engines 110A-N can be configured to construct a sketch based on the fingerprints. The sketch engines 110A-N can be configured to compress events into a sketch and estimate a frequency distribution of the users by tracking the frequency of the largest fingerprint per register of the sketch. The secret share engines 112A-N can be configured to secret-share the sketch. The secret share engine 112A-N can be configured to utilize any secret sharing technique, such as splitting different quantities into different types of secret shares, e.g., splitting fingerprints into binary shares but frequencies into arithmetic shares.

The multi-party computation system 100 can include a merge engine 114, an aggregation engine 116, and a histogram engine 118. The merge engine 114, aggregation engine 116, and histogram engine 118 can be implemented as one or more computer programs, specially configured electronic circuitry, or any combination thereof. The merge engine 114 can be configured to merge registers representing the sketches. The merge engine 114 can be configured to merge the sketches, where the fingerprints are binary shares and the frequencies are arithmetic shares. The aggregation engine 116 can be configured to aggregate the registers. The histogram engine 118 can be configured to compute a frequency histogram based on the aggregated registers. The histogram engine 118 can be configured to generate a reach and frequency histogram with differentially private noises added to produce a noisy output.

The client computing device 106 can include a debias engine 120. The debias engine 120 can be implemented as one or more computer programs, specially configured electronic circuitry, or any combination thereof. The debias engine 120 can be configured to debias the frequency histogram based on the reach estimate. The debias engine 120 can be configured to debias frequency folding.

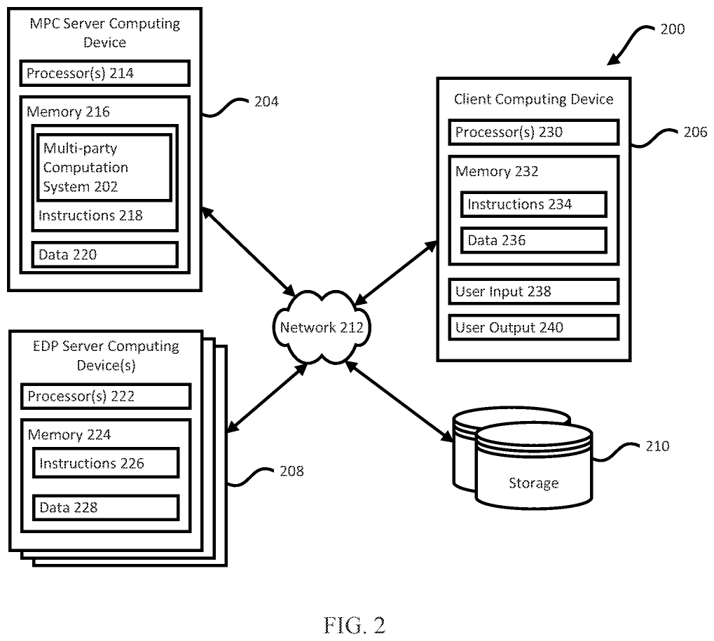

FIG. 2 depicts a block diagram of an example environment 200 for implementing a multi-party computing system 202. The multi-party computing system 202 can be implemented on one or more devices having one or more processors in one or more locations, such as in multi-party computing (MPC) server computing device 204. Client computing device 206, one or more event data provider (EDP) server computing devices 208, and the MPC server computing device 204 can be communicatively coupled to one or more storage devices 210 over a network 212. The storage devices 210 can be a combination of volatile and non-volatile memory and can be at the same or different physical locations than the computing devices 204-208. For example, the storage devices 210 can include any type of transitory or non-transitory computer readable medium capable of storing information, such as a hard-drive, solid state drive, tape drive, optical storage, memory card, ROM, RAM, DVD, CD-ROM, write-capable, and read-only memories.

The MPC server computing device 204 can include one or more processors 214 and memory 216. The memory 216 can store information accessible by the processors 214, including instructions 218 that can be executed by the processors 214. The memory 216 can also include data 220 that can be retrieved, manipulated, or stored by the processors 214. The memory 216 can be a type of transitory or non-transitory computer readable medium capable of storing information accessible by the processors 214, such as volatile and non-volatile memory. The processors 214 can include one or more central processing units (CPUs), graphic processing units (GPUs), field-programmable gate arrays (FPGAs), and/or application-specific integrated circuits (ASICs), such as tensor processing units (TPUs).

The instructions 218 can include one or more instructions that, when executed by the processors 214, cause the one or more processors 214 to perform actions defined by the instructions 218. The instructions 218 can be stored in object code format for direct processing by the processors 214, or in other formats including interpretable scripts or collections of independent source code modules that are interpreted on demand or compiled in advance. The instructions can include instructions for implementing a multi-party computation system 202, which can correspond to the multi-party computation system 100 of FIG. 1. The multi-party computation system 202 can be executed using the processors 214, and/or using other processors remotely located from the MPC server computing device 204.

The data 220 can be retrieved, stored, or modified by the processors 214 in accordance with the instructions 218. The data 220 can be stored in computer registers, in a relational or non-relational database as a table having a plurality of different fields and records, or as JSON, YAML, proto, or XML documents. The data 220 can also be formatted in a computer-readable format such as, but not limited to, binary values, ASCII, or Unicode. Moreover, the data 220 can include information sufficient to identify relevant information, such as numbers, descriptive text, proprietary codes, pointers, references to data stored in other memories, including other network locations, or information that is used by a function to calculate relevant data.

The one or more EDP server computing devices 208 can be configured similarly to the MPC server computing device 204, with one or more processors 222, memory 224, instructions 226, and data 228. The client computing device 206 can also be configured similarly to the MPC server computing device 204, with one or more processors 230, memory 232, instructions 234, and data 236. The client computing device 206 can also include a user input 238 and a user output 240. The user input 238 can include any appropriate mechanism or technique for receiving input from a user, such as keyboard, mouse, mechanical actuators, soft actuators, touchscreens, microphones, and sensors.

The MPC server computing device 204 and/or the EDP server computing devices 208 can be configured to transmit data to the client computing device 206, and the client computing device 206 can be configured to display at least a portion of the received data on a display implemented as part of the user output 240. The user output 240 can also be used for displaying an interface between the client computing device 206 and the MPC server computing device 204 and/or EDP server computing devices 208. The user output 240 can alternatively or additionally include one or more speakers, transducers or other audio outputs, a haptic interface or other tactile feedback that provides non-visual and non-audible information to the platform user of the client computing device 206.

Although FIG. 2 illustrates the processors and the memories as being within the computing devices 204-208, components described herein can include multiple processors and memories that can operate in different physical locations and not within the same computing device. For example, some of the instructions and the data can be stored on a removable SD card and others within a read-only computer chip. Some or all of the instructions and data can be stored in a location physically remote from, yet still accessible by, the processors. Similarly, the processors can include a collection of processors that can perform concurrent and/or sequential operation. The computing devices 204-208 can each include one or more internal clocks providing timing information, which can be used for time measurement for operations and programs run by the computing devices 204-208.

The computing devices 204-208 can be capable of direct and indirect communication over the network 212. For example, using a network socket, the client computing device 206 can connect through an Internet protocol. The computing devices 204-208 can set up listening sockets that may accept an initiating connection for sending and receiving information. The network 212 itself can include various configurations and protocols including the Internet, World Wide Web, intranets, virtual private networks, wide area networks, local networks, and private networks using communication protocols proprietary to one or more companies. The network 212 can support a variety of short-and long-range connections. The short-and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 212, in addition or alternatively, can also support wired connections between the computing devices 204-208, including over various types of Ethernet connection.

Although a single MPC server computing device 204, client computing device 206, and EDP server computing device 208 are shown in FIG. 2, it is understood that the aspects of the disclosure can be implemented according to a variety of different configurations and quantities of computing devices, including in paradigms for sequential or parallel processing, or over a distributed network of multiple devices.

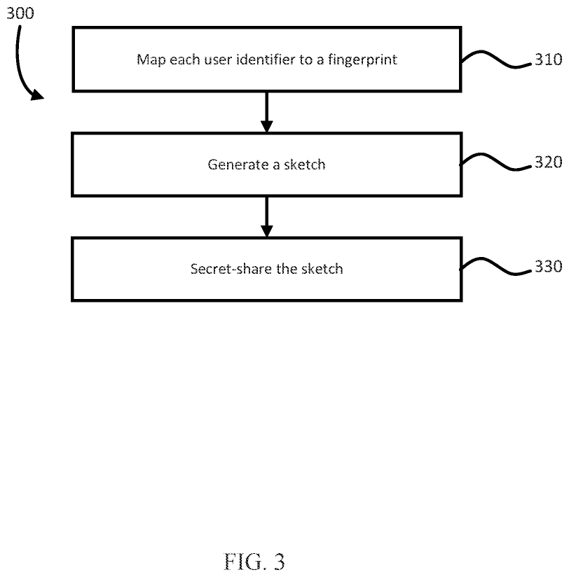

FIG. 3 depicts a flow diagram of an example process 300 for generating sketches that are used to estimate a frequency histogram. The example process 300 can be performed on a system of one or more processors in one or more locations, such as by one or more of the event data providers 102A-N as depicted in FIG. 1. The example process 300 can also be performed by the multi-party computation system 100 as depicted in FIG. 1.

As shown in block 310, each event data provider 102A-N can map a user identifier to a fingerprint. Each event data provider 102A-N can non-uniformly map its user identifiers to fingerprints, where the largest fingerprint tracked is unlikely to have collisions with other user identifiers, therefore corresponding to a unique user identifier. For example, for each user identifier x, each event data provider 102A-N can define the fingerprint of the respective user identifier as a fingerprint bit length integer: fgp(x)=floor(2^{B}^{_{fgp}}×exp[−a×h_{fgp}(x)]), where floor denotes a floor function, B_{fgp} denotes the fingerprint bit length, a is a “decay rate” parameter, and h_{fgp} is a hash function that maps any identifier into (0, 1). Each event data provider i 102A-N can calculate the fingerprint of the user identifiers the event data provider reached, e.g., calculate fgp(x) if and only if freq(x,i)>0. When a sampling rate is specified, such as from the client computing device 106, each event data provider 102A-N can determine the fingerprint and perform the following steps on the sampled user identifiers.

As shown in block 320, each event data provider 102A-N can generate a sketch based on the fingerprints. Each event data provider 102A-N can compress events from the user identifiers into a sketch and estimate frequency distribution of the users by tracking the frequency of the largest fingerprint per register of the sketch. For example, each event data provider 102A-N can construct a sketch that is an array of length m. Each element of the array can be referred to as a register. Each register can contain information to be defined below. For each user identifier x, each event data provider i can determine its register index as: register(x)=floor(m×hₛ(x)). Then, for 1≤r≤m, each event data provider 102A-N can collect the reached user identifiers that fall in the rth register, e.g., find the set Xᵣ(i)={x: freq(x,i)>0 and register(x)=r}. From Xᵣ(i), each event data provider 102A-N can pick the user identifier with the largest frequency and record its frequency. For example, each event data provider 102A-N can have xᵣ(i)=arg max_{x∈X}_{ᵣ}₍ᵢ₎fgp(x), and can record fgpᵣ(i)=fgp(xᵣ(i)) and freqᵣ(i)=freq(xᵣ(i),i). If Xᵣ(i) is an empty set, then the ith event data provider can have fgpᵣ(i)=0 and freqᵣ(i)=0. If an event data provider determines the solution x of arg max_{x∈X}_{ᵣ}₍ᵢ₎fgp(x) is not unique, e.g., there are multiple user identifiers that have the largest fingerprint, then the event data provider defines freqᵣ(i) as the summation of the frequencies of these user identifiers. Each event data provider 102A-N can record a tuple (fgpᵣ(i), freqᵣ(i)) in the r^{th} register.

As shown in block 330, each event data provider 102A-N can secret-share the sketch. Each event data provider 102A-N can be configured to utilize any secret sharing technique. For example, each event data provider 102A-N can split different quantities into different types of secret shares, such as splitting fingerprints into binary shares and frequencies into arithmetic shares. For each register r, each event data provider i 102A-N can randomly split the tuple (fgpᵣ(i), freqᵣ(i)) into W shares. Each event data provider 102A-N can split fgpᵣ(i) into W binary shares [fgpᵣ(i)]_{W}^{B}, each of B_{fgp} bits, where ⊕_{w=1}^{W}[fgpᵣ(i)]_{W}^{B}=fgpᵣ(i). As an example, B_{fgp} can be 8. Each event data provider 102A-N can split freqᵣ(i) into W arithmetic shares in the B_{freq}-bit field Zp, e.g., generate W integers [freqᵣ(i)]_{w}∈Zₚ, each of B_{freq} bits, where Σ_{w=1}^{W}[freqᵣ(i)]_{w}=freqᵣ(i)(mod p). As an example, B_{freq} can be 16. Each event data provider i can send the w^{th} share of the sketch ([fgpᵣ(i)]_{W}^{B}, [freqᵣ(i)]_{W})_{1≤r≤m} to worker w, for 1≤w≤W.

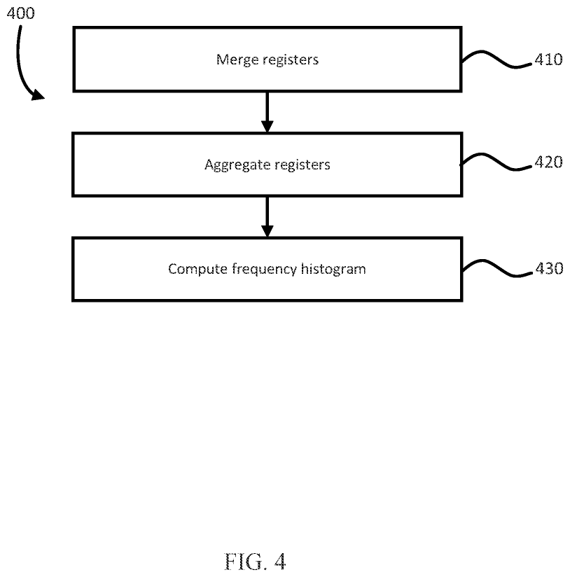

FIG. 4 depicts a flow diagram of an example process 400 for generating a frequency histogram. The example process 400 can be performed on a system of one or more processors in one or more locations, such as by the multi-party computation system 100 as depicted in FIG. 1. The multiparty computation system 100 can obliviously merge the sketches and estimate the frequency histogram by securely performing multiparty computation via binary and arithmetic secret sharing as well as masking the frequency histogram with differential privacy noise.

As shown in block 410, the multi-party computation system 100 can merge registers. The multi-party computation system 100 can merge sketches where the fingerprints are binary shares and the frequencies are arithmetic shares. For example, the multi-party computation system 100 can receive the shares of the sketches from the event data providers 102A-N. The multi-party computation system 100 can obliviously merge the sketches using multi-party computation. The sketches are merged obliviously due to different workers of the multi-party computation system 100 receiving random shares of the sketches. For example, two registers (fgpᵣ(1), freqᵣ(1)) and (fgpᵣ(2), freqᵣ(2)) can be merged as follows: If the fingerprints are different, then the greater fingerprint is kept together with its frequency; otherwise, the frequencies are added. The multi-party computation system 100 can perform the oblivious merging via a mixed circuit that includes both binary gates, e.g., AND, XOR, and/or NOT, and arithmetic gates, e.g., ADD and/or MUL. Below is an example procedure for merging registers.

Input: shares {([fgpᵣ(1)]^{B}, [freqᵣ(1)])_{1≤r≤m}, . . . , ([fgpᵣ(p)]^{B}, [freqᵣ(p)])_{1≤r≤m}}.

Output: shares of merged tuples ([fpgᵣ]^{B}, [freqᵣ])_{1≤r≤m}.

Protocol: ([fpgᵣ]^{B}, [freqᵣ])_{1≤r≤m}←([fpgᵣ(1)]^{B}, [freqᵣ(1])_{1≤r≤m};

For r=1, . . . , m, and j=2, . . . , p, the workers compute:

$$\begin{matrix}{[ {u}_{r} ]}^{B} ← e q ( {[ {fpg}_{r} ]}^{B} , {[ {fpg}_{r} ( j ) ]}^{B} ≡ {[ {fpg}_{r} == {fpg}_{r} ( j ) ]}^{B} ; \\ {[ {v}_{r} ]}^{B} ← g t ( {[ {fpg}_{r} ]}^{B} , {[ {fpg}_{r} ( j ) ]}^{B} ≡ {[ {fpg}_{r} > {fpg}_{r} ( j ) ]}^{B} ; \\ {[ {fpg}_{r} ]}^{B} ← {[ {fpg}_{r} ( j ) ]}^{B} ⊕ ( {[ {fpg}_{r} ( j ) ]}^{B} ⊕ {[ {fpg}_{r} ]}^{B} ) \cdot {[ {v}_{r} ]}^{B} ; \\ [ {u}_{r} ] ← B 2 A ( {[ {u}_{r} ]}^{B} ) ; \\ [ {v}_{r} ] ← B 2 A ( {[ {v}_{r} ]}^{B} ) ; \\ [ {freq}_{r} ] ← ( [ {freq}_{r} ] - [ {freq}_{r} ( j ) ] ) * [ {v}_{r} ] + [ {freq}_{r} ] * [ {u}_{r} ] + [ {freq}_{r} ( j ) ] .\end{matrix}$$

The multi-party computation system 100 can set a temporary output to be the vector of shares of the first EDP. The multi-party computation system 100 can start merging the temporary output with the input of the next EDP, one by one. The multi-party computation system 100 compares the two fingerprints and obtains the binary shares [uᵣ]^{B} and [vᵣ]^{B}. The bit uᵣ can indicate whether the two fingerprints are equal, e.g., 1=yes and 0=no. The bit vᵣ can indicate whether the fingerprint of the temporary output is greater than that of the output of the next EDP. The multi-party computation system 100 can compute the merged fingerprint, convert the binary shares [uᵣ]^{B} and [vᵣ]^{B} to arithmetic shares [uᵣ] and [vᵣ], and compute the merged frequency count between the temporary output and the frequency count of the next EDP.

As shown in block 420, the multi-party computation system 100 can aggregate the merged registers to generate aggregated registers. For example, the multi-party computation system 100 can add the merged registers.

As shown in block 430, the multi-party computation system 100 can compute a frequency histogram based on the aggregated registers and add differentially private noise to produce a noisy output. For example, once the sketches have been merged and aggregated, the multi-party computation system 100 can proceed with the computation of the frequency histogram.

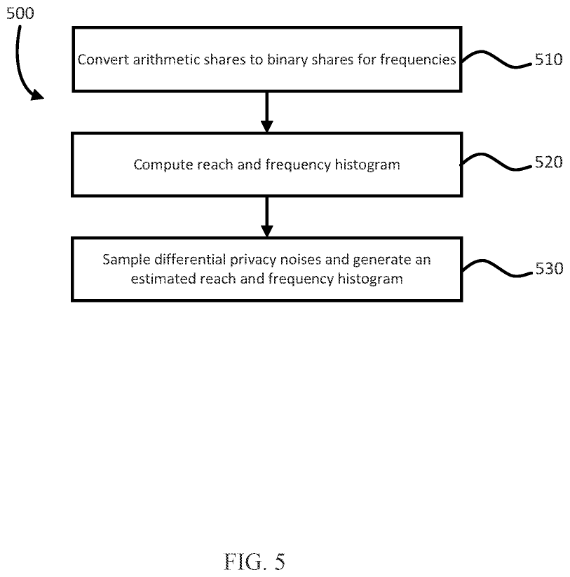

FIG. 5 depicts a flow diagram of an example process 500 for computing the frequency histogram. The example process 500 can be performed on a system of one or more processors in one or more locations, such as by the multi-party computation system 100 as depicted in FIG. 1. Below is an example procedure for frequency histogram estimation.

Input: ([freqᵣ])_{1≤r≤m}.

Output: [\hat{n}], ( [symbol] ])_{1≤k≤K-1}, and [ [symbol] ]. Protocol:

Convert arithmetic share to binary share for frequencies:

For r=1, . . . , m, [freqᵣ]^{B}←A2B([freqᵣ]).

Compute the reach and frequency histogram:

$$For k = 0 , … , K - 1 :$$

$$For r = 1 , … , m , {[ {b}_{r} ]}^{B} ← e q ( {[ {freq}_{r} ]}^{B} , {[ k ]}^{B} ) ;$$

$${[ {n}_{k} ]}^{B} ← Add ( {[ {b}_{1} ]}^{B} , … , {[ {b}_{m} ]}^{B} ) ; and$$

$$[ {n}_{k} ] ← B 2 A ( {[ {n}_{k} ]}^{B} ) ;$$

$$[ {n}_{K +} ] ← m - {\sum }_{k = 0}^{K - 1} [ {n}_{k} ] ; and$$

$$[ n ] ← m - [ {n}_{0} ] .$$

Sample differential privacy noises and generate the estimated reach and frequency histogram:

For k=0, . . . , K−1:

Worker w samples differentially private noise λ_{w,k}; and

[ [symbol] ]_{w}←[nₖ]_{w}+λ_{w,k}; and

Worker w samples differentially private noises λ_{w} and λ_{w,K+} and sets:

$${[ ]}_{w} ← {[ {n}_{K +} ]}_{w} + {λ}_{w , K +} ; and$$

$${[ \hat{n} ]}_{w} ← {[ n ]}_{w} + {λ}_{w} .$$

The input can be a vector of arithmetic shares having a size m and index r. The output can be a share of the noisy reach, the noisy frequency count, and the noisy count for all frequencies that are greater than or equal to the maximum frequency. The multi-party computation system 100 can convert arithmetic shares to binary shares. freqᵣ can be decomposed into binary bits, where the workers hold the binary shares [freqᵣ]^{B} of these bits. The multi-party computation system 100 can check if [freqᵣ]^{B} is equal to the frequency value k. The output of the equality check is [bᵣ]^{B} where the workers hold a binary share of [bᵣ]^{B}. The multi-party computation system 100 can count the number of registers that have the frequency value k by adding all the bits obtained from the equality check. The workers can hold the binary shares of the output bits. The multi-party computation system 100 can convert the binary shares representing the frequency count k to the arithmetic shares. The multi-party computation system 100 can obtain the total number of registers with a frequency of at least K, the maximum frequency, by subtracting the lower frequency counts from the number of registers. The multi-party computation system 100 can compute reach by subtracting the number of registers with frequency 0 from the number of registers. The multi-party computation system 100 can add differential privacy noise, e.g., Gaussian noise, to the output.

As shown in block 510, the multi-party computation system 100 can convert arithmetic shares to binary shares for frequencies. For example, the multi-party computation system 100 can convert the arithmetic shares ([freqᵣ])_{1≤r≤m} to binary shares ([freqᵣ]^{B})_{1≤r≤m}. Any arithmetic to binary procedure can be utilized. For instance, below is an example procedure for converting arithmetic shares to binary shares.

Input: [x] is the arithmetic share of x in Z_{q}.

Output: [x]^{B}=([xₗ₋₁]^{B}, . . . , [x₀]^{B}) is the binary share where x=Σᵢ₌₀^{l-1}2ⁱxᵢ(mod q).

Protocol: The workers first sample random binary share [r]^{B}=([rₗ₋₁]^{B}, . . . , [r₀]^{B}) and compute:

$$[ {r}_{i} ] ← B 2 A ( {[ {r}_{i} ]}^{B} ) ;$$

$$[ r ] ← {\sum }_{i = 0}^{l - 1} {2}^{i} [ {r}_{i} ] ;$$

$$[ x - r ] = [ x ] - [ r ] ;$$

$$Reveal ( x - r ) ∈ {Z}_{q} ;$$

$${[ x ]}^{B} ← RippleCarryAdder ( ( x - r ) , {[ r ]}^{B} ) ;$$

$$[ b ] ← g t ( {[ x ]}^{B} , {[ q ]}^{B} ) ⊕ e q ( {[ x ]}^{B} , {[ q ]}^{B} ) ;$$

$${[ x ]}^{B} ← {[ x ]}^{B} - [ b ] \cdot q .$$

The multi-party computation system 100 can sample a random binary share and convert each binary share to an arithmetic share. The multi-party computation system 100 can compute the arithmetic share of r, which has the binary representation (rₗ₋₁, . . . , r₀). The multi-party computation system 100 can compute a masked value (x−r) of xand add it with [r]^{B}, the binary shares of r. The multi-party computation system 100 can then obtain a binary share of x. The multi-party computation system 100 can check if the sum is greater than or equal to a value qand ensure that x is in [0, q−1].

As shown in block 520, the multi-party computation system 100 can compute a reach and frequency histogram. Computing the reach and frequency histogram can include performing a secure equality check and comparison.

For a frequency k∈[0, . . . , (K−1)], the multi-party computation system 100 can go through the registers and check if each frequency is equal to k. Each check yields a binary share of an indication bit 0/1. For the equality/inequality check, the multi-party computation system 100 can securely compare two binary shares, where the output is binary shares of two bits: one indicating whether the two input binary shares are equal and the other indicating if the first input is greater than the second input. First, the multi-party computation system 100 can split the input shares of equal length into two halves: x=x_{left}∥x_{right} and y=y_{left}∥y_{right}. The left can contain the most significant bits and length(x_{left})=length(y_{left}), length(x_{right})=length(y_{right}). The two numbers x and y can be equal to each other if both the left and the right part are equal, and x can be greater than y if either x_{left}>y_{left} or x_{left}==y_{left} AND x_{right}>y_{right}. Below is an example procedure for a secure equality check and comparison.

Input: two binary shares [x]^{B}=([xₗ₋₁]^{B}, . . . , [x₀]^{B}) and [y]^{B}=([yₗ₋₁]^{B}, . . . , [y₀]^{B}) where xᵢ, yᵢ∈{0,1} and x=Σᵢ₌₀^{l-1}2ⁱxᵢ and y=Σᵢ₌₀^{l-1}2ⁱyᵢ.

Output: shares of two indication bits [e]←eq([x]^{B}, [y]^{B})←[x==y]^{B} and [g]←gt([x]^{B}, [y]^{B})≡[x>y]^{B}.

Protocol:

Base cases: for two bits b₁ and b₂:

eq([b₁]^{B}, [b₂]^{B})≡1⊕[b₁]^{B}⊕[b₂]^{B}//Free;

gt([b₁]^{B}, [b₂]^{B})≡[b₁]·(1⊕[b₂])//Cost 1 multiplication;

Let x=x_{left}∥x_{right} and y=y_{left}∥y_{right}:

$$eq ( {[ x ]}^{B} , {[ y ]}^{B} ) ← e q ( {[ {x}_{left} ]}^{B} , {[ {y}_{left} ]}^{B} ) \cdot eq ( {[ {x}_{right} ]}^{B} , {[ {y}_{right} ]}^{B} ) ;$$

$$gt ( {[ x ]}^{B} , {[ y ]}^{B} ) ← g t ( {[ {x}_{left} ]}^{B} , {[ {y}_{left} ]}^{B} ) ⊕ e q ( {[ {x}_{left} ]}^{B} , {[ {y}_{left} ]}^{B} ) \cdot gt ( {[ {x}_{right} ]}^{B} , {[ {y}_{right} ]}^{B} ) .$$

The multi-party computation system 100 can start with a base case where inputs are 1-bit binary shares. If the inputs are longer than 1 bit, the multi-party computation system 100 can split the inputs into 2 halves, where the left half contains the most significant bits. The multi-party computation system 100 can continue to perform the equality check for both halves. x and y are equal if the left of x and y are equal, and the right of x and y are equal. x is greater than y if the left of x is greater than that of y or the left of x is equal to that of y and the right of x is greater than that of y.

Computing the reach and frequency histogram can further include adding the bits, such as to get the binary share [nₖ]^{B} of nₖ. The multi-party computation system 100 can add binary shares of m bits ([bᵣ]^{B})_{1≤r≤m} together. Any procedure for adding bits can be utilized, such as a recursive approach. For instance, below is an example procedure for adding bits.

Input: binary shares of m bits ([bᵣ]^{B})_{1≤r≤m}.

Output: binary shares [sum]^{B}←[Σᵣ₌₁^{m}bᵣ]^{B}.

Protocol:

If m=1, return [b₁]^{B};

Else if m=2, return RippleCarryAdder([b₁]^{B}, [b₂]^{B});

Else:

$${sum}_{l} ← Add ( {[ {b}_{1} ]}^{B} , … , {[ {b}_{m / 2} ]}^{B} ) ;$$

$${sum}_{r} ← Add ( {[ {b}_{1 + m / 2} ]}^{B} , … , {[ {b}_{m} ]}^{B} ) ;$$

[sum]^{B}←RippleCarryAdder(sumₗ, sumᵣ);

Return [sum]^{B}.

If there is only 1 bit, the multi-party computation system 100 can return that bit. Otherwise, the multi-party computation system 100 can use the ripple carry adder to add two bits if the length is 2 and, if the length is greater than 2 bits, the multi-party computation system 100 can split the input bits into 2 parts, calling the add function on the first m/2 bits and the add function on the second m/2 bits, and adding the left and right sum to get the result.

As another example, below is an example procedure for adding two binary shares of equal bit length.

Input: two binary shares [x]^{B}=([xₗ₋₁]^{B}, . . . , [x₀]^{B}) and [y]^{B}=([yₗ₋₁]^{B}, . . . , [y₀]^{B}).

Output: binary share [z]^{B}=([zₗ]^{B}, . . . , [z₀]^{B}).

Protocol:

[c]^{B}←0;

For i=0, . . . , l−1, do:

$${[ {z}_{i} ]}^{B} ← {[ c ]}^{B} ⊕ {[ {x}_{i} ]}^{B} ⊕ {[ {y}_{i} ]}^{B} ; and$$

$${[ c ]}^{B} ← {[ c ]}^{B} \cdot ( {[ {x}_{i} ]}^{B} ⊕ {[ {y}_{i} ]}^{B} ) ⊕ ( {[ {x}_{i} ]}^{B} \cdot {[ {y}_{i} ]}^{B} ) ;$$

$${[ {z}_{l} ]}^{B} ← {[ c ]}^{B} .$$

The multi-party computation system 100 can set the carry bit to 0, compute the ith output bit, and compute the carry bit. The sum will be 1 bit longer than the input, where the extra bit will be the final carry bit.

Computing the reach and frequency histogram can also include converting the binary shares to arithmetic shares, such as the binary share [nₖ]^{B} to the arithmetic share [nₖ]. Any binary to arithmetic procedure can be utilized. For instance, below is an example procedure for converting binary shares to arithmetic shares.

Input: [x]^{B} is the binary share of the bit x∈{0,1}.

Output: [x] be the arithmetic share of x in Z_{q}.

Protocol: Each worker P_{w} samples r_{w}←Z₂ uniformly at random and creates a pair of secret shares ([r_{w}]^{B}, [r_{w}]) and distributes them to other workers, who compute:

[r]←[r₁];

For w=2, . . . , W, [r]←[r]+[r_{w}]−2([r]*[r_{w}]);

[r]^{B}←⊕_{w=1}^{W}[r_{w}]^{B}//Compute locally;

[d]^{B}←[x]^{B}⊕[r]^{B}//Compute locally;

Reveal d∈{0,1};

Compute [x]=d⊕[r]_{A}=d+[r]_{A}−2(d*[r]).

The multi-party computation system 100 can compute the XOR of rᵢ in arithmetic form, compute the XOR of rᵢ in binary form, and compute the masked value of x. The multi-party computation system 100 can remove the mask from (x\XOR r) to get the arithmetic share of x.

As shown in block 530, the multi-party computation system 100 can sample differentially private noise, which can be added to the arithmetic share [nₖ] to get an estimated arithmetic share [ [symbol] ]. The multi-party computation system 100 can compute reach [\hat{n}] and count k+ reaches [\hat{n}_{K+}] based on sketch size m and previously computed [ [symbol] ]_{0≤k≤K-1}. Once the multi-party computation system 100 computes the shares, they can output them, such as to the client computing device 106.

The client computing device 106 can compute a frequency probability mass function (pmf) [r₁, . . . , r_{K-1}, r_{K+}] where rₖ=\hat{n}ₖ/Σ_{i∈{1, . . . , K-1, K+}}\hat{n}ᵢ. The client computing device 106 can be configured to debias the frequency histogram based on the reach estimate. The client computing device 106 can be configured to debias frequency folding. Frequency folding can refer to multiple user identifiers having the largest fingerprint in a register. Here, total frequency of these user identifiers is tracked. With B_{fgp}=8, a=8.0, and B_{freq}=16, the probability of frequency folding can be controlled below 2%, so the bias can be about below 2%. Under a 95-10 target accuracy, this bias is negligible, but under stricter target accuracies, such as 95-2, this bias can be corrected with a reach estimate ñ.

The client computing device 106 can estimate frequency folding probabilities from \hat{n}. Each register can have \hat{n}/m reached user identifiers on average. The client computing device 106 can simulate mapping these \hat{n}/m user identifiers to fingerprints as if they were event data providers and determine how many user identifiers have the largest fingerprint. With multiple replicates, the client computing device 106 can estimate πₖ, which is the probability that k user identifiers share the largest fingerprint for k=1,2, . . .

The client computing device 106 can debias a frequency probability mass (pmf) based on the frequency folding probabilities. As an example, given [r₁, . . . , r_{K-1}, r_{K+}] as the frequency pmf that is provided to the client computing device 106, the client computing device 106 can determine [d, . . . , d_{K-1}, d_{K+}] as the debiased pmf based on the following sequentially solving for dₖ's using dynamic programming:

$${d}_{1} = \frac{{r}_{1}}{{π}_{1}} ;$$

$${d}_{2} = \frac{( {r}_{2} - {π}_{2} {d}_{1}^{2} )}{{π}_{1}} ;$$

$${d}_{3} = \frac{( {r}_{2} - {π}_{2} \cdot 2 {d}_{1} {d}_{2} - {π}_{3} {d}_{1}^{3} )}{{π}_{1}} ;$$

$${d}_{4} = \frac{[ {r}_{4} - {π}_{2} \cdot ( 2 {d}_{1} {d}_{3} + {d}_{2}^{2} ) + {π}_{3} \cdot 3 {d}_{1}^{2} {d}_{2} + {π}_{4} {d}_{1}^{4} ]}{{π}_{1}} ,$$

. . . etc.

As illustrated in the below tables, the multi-party computation system 100 can significantly reduce computational cost, e.g., computational resources to run the system, by about 90%, in estimating frequency histograms while maintaining or improving accuracy and/or security. The first table depicts the computational cost per ad analysis report of the multi-party computation system 100 compared to a baseline approach for different regions as well as a total of all regions. The second table depicts the computation cost per day for 200 ad analysis reports of the multi-party computation system 100 compared to the baseline approach for different regions as well as a total of all regions.

Computational Cost per Report

| | Per Region | All Regions |
|---|---|---|
| Baseline Approach | $139.60 | $279.21 |
| Multi-Party Computation | $10.04 | $30.11 |
| Approach | | |

Computational Cost per Day based on 200 Reports

| | Per Region | All Regions |
|---|---|---|
| Baseline Approach | $30,920 | $61,841 |
| Multi-Party Computation | $2007.49 | $6,022.48 |
| Approach | | |

The multi-party computation system 100 can use frequency information from all registers, whereas the baseline approach may only use partial registers, e.g., registers that contain only one identifier. By using all registers, the multi-party computation system 100 can achieve the same or improved accuracy with fewer registers with the same level of noise for privacy. Further, the multi-party computation system 100 can maintain secret sharing techniques where no particular worker can see the estimated frequency histograms being output. Overall, the multi-party computation system can save about 90% cost while maintaining accuracy, privacy, and security.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed on it software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a stand alone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components, or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for estimating a frequency histogram, comprising:
receiving, by one or more processors, a plurality of secret-shared sketches from a plurality of event data providers;
obliviously merging, by the one or more processors, the secret-shared sketches to generate registers;
aggregating, by the one or more processors, the registers to generate a frequency histogram; and
adding, by the one or more processors, differentially private noise to the frequency histogram.

2. The method of claim 1, further comprising debiasing, by the one or more processors, the frequency histogram based on a reach estimate.

3. The method of claim 2, wherein debiasing the frequency histogram further comprises debiasing frequency folding.

4. The method of claim 1, wherein, in merging the secret-shared sketches, fingerprints are binary shares and frequencies are arithmetic shares.

5. The method of claim 1, wherein, in merging the secret-shared sketches, if fingerprints of two secret-shared sketches are different, then the greater fingerprint is kept together with its frequency, while if the fingerprints are the same, then the frequencies are added together.

6. The method of claim 1, wherein aggregating the registers further comprises:
converting arithmetic shares to binary shares;
performing an equality/inequality check on the binary shares;
adding the binary shares together; and
converting the binary shares to arithmetic shares.

7. The method of claim 1, further comprising:
non-uniformly mapping, by the one or more processors, a user identifier to a fingerprint;
generating, by the one or more processors, a sketch based on the mapping; and
secret-sharing, by the one or more processors, the sketch to generate a secret-shared sketch of the plurality of secret-shared sketches.

8. The method of claim 7, wherein, in non-uniformly mapping the user identifier to the fingerprint, the largest fingerprint tracked is unlikely to have collisions with other user identifiers.

9. The method of claim 7, wherein generating the sketch further comprises compressing events from the user identifier and estimating a frequency distribution by tracking the frequency of the largest fingerprint per register.

10. The method of claim 7, wherein secret-sharing the sketch further comprises splitting fingerprints into binary shares and frequencies into arithmetic shares.

11. A system comprising:
one or more processors; and
one or more storage devices coupled to the one or more processors and storing instructions that, when executed by the one or more processors, cause the one or more processors to perform operations for estimating a frequency histogram, the operations comprising:
receiving a plurality of secret-shared sketches from a plurality of event data providers;
obliviously merging the secret-shared sketches to generate registers;
aggregating the registers to generate a frequency histogram; and
adding differentially private noise to the frequency histogram.

12. The system of claim 11, wherein the operations further comprise debiasing the frequency histogram based on a reach estimate.

13. The system of claim 11, wherein, in merging the secret-shared sketches, fingerprints are binary shares and frequencies are arithmetic shares.

14. The system of claim 11, wherein, in merging the secret-shared sketches, if fingerprints of two secret-shared sketches are different, then the greater fingerprint is kept together with its frequency, while if the fingerprints are the same, then the frequencies are added together.

15. The system of claim 11, wherein aggregating the registers further comprises:
converting arithmetic shares to binary shares;
performing an equality/inequality check on the binary shares;
adding the binary shares together; and
converting the binary shares to arithmetic shares.

16. The system of claim 15, wherein the operations further comprise:
non-uniformly mapping a user identifier to a fingerprint;
generating a sketch based on the mapping; and
secret-sharing the sketch to generate a secret-shared sketch of the plurality of secret-shared sketches.

17. The system of claim 16, wherein, in non-uniformly mapping the user identifier to the fingerprint, the largest fingerprint tracked is unlikely to have collisions with other user identifiers.

18. The system of claim 16, wherein generating the sketch further comprises compressing events from the user identifier and estimating a frequency distribution by tracking the frequency of the largest fingerprint per register.

19. The system of claim 16, wherein secret-sharing the sketch further comprises splitting fingerprints into binary shares and frequencies into arithmetic shares.

20. A non-transitory computer readable medium for storing instructions that, when executed by the one or more processors, cause the one or more processors to perform operations for estimating a frequency histogram, the operations comprising:
receiving a plurality of secret-shared sketches from a plurality of event data providers;
obliviously merging the secret-shared sketches to generate registers;
aggregating the registers to generate a frequency histogram; and
adding differentially private noise to the frequency histogram.
